(19) United States
(12) Patent Application Publication
(10) Pub. No.: US 2026/0222517 A1
(43) Pub. Date: Jul. 30, 2026

(54) IMAGING DEVICE, METHOD FOR CONTROLLING IMAGING DEVICE, AND NON-TRANSITORY COMPUTER READABLE MEDIUM

(71) Applicant: CANON KABUSHIKI KAISHA, Tokyo (JP)

(72) Inventor: SHUICHIRO MATSUSHIMA, Tokyo (JP)

(21) Appl. No.: 19/629,549

(22) Filed: Mar. 26, 2026

Related U.S. Application Data
(63) Continuation of application No. PCT/JP2024/027284, filed on Jul. 31, 2024.

(30) Foreign Application Priority Data
Oct. 6, 2023 (JP) 2023-174203

(51) Int. Cl. H04N 5/907; H04N 23/80

(52) U.S. Cl. CPC H04N 5/907; H04N 23/80

(57) ABSTRACT

An imaging device includes a first operation member capable of receiving a first operation and a second operation member capable of receiving a second operation. The imaging device, in a case where the first operation member receives the first operation, controls an image sensor to perform photographing and record a photographed image, which has been acquired by the photographing, on a recording medium, and in a case where the second operation member receives the second operation, records a first image on the recording medium. The imaging device, even in a case where the second operation member has received the second operation, in a case where an image recorded on the recording medium immediately before is the first image, does not record the first image on the recording medium.

### CROSS-REFERENCE TO RELATED APPLICATIONS

This application is a Continuation of International Patent Application No. PCT/JP2024/027284, filed July 31, 2024, which claims the benefit of Japanese Patent Application No. 2023-174203, filed October 6, 2023, both of which are hereby incorporated by reference herein in their entirety.

### BACKGROUND

### Field of the Technology

The present disclosure relates to an imaging device, a method for controlling an imaging device, and a non-transitory computer readable medium.

### DESCRIPTION OF THE RELATED ART

When a list of images acquired by a camera through continuous shooting is displayed, many thumbnail images having similar images may be displayed side by side. For this reason, a user may not be able to visually distinguish separations between a plurality of consecutive photographed images. Therefore, Japanese Patent Laid-Open No. 2008-244778 describes a technology that acquires predetermined separations in photographic information and generates "separator images that are images to be displayed at the positions of separations when displaying a list of a plurality of photographed images".

In Japanese Patent Laid-Open No. 2008-244778, when predetermined conditions are satisfied, a separator image is automatically generated and recorded on a medium without the user being aware of this, which. makes it possible to eliminate the user's laborious operation to generate and record separator images. However, in this technology, the conditions for recording (generating) a separator image are fixed. Thus, it has not been possible for the user to record the separator image on a medium at a timing intended by the user.

### SUMMARY

Therefore, the present disclosure provides an imaging device that, when recording a plurality of photographed images on a medium, can record a separator image on the medium at a timing intended by the user.

One aspect of the present disclosure is an imaging device including an image sensor, a first operation member capable of receiving a first operation to instruct the image sensor to perform photographing, a second operation member capable of receiving a second operation, and a processor configured to, 1) in a case where the first operation member receives the first operation, control the image sensor to perform photographing and record a photographed image, which has been acquired by the photographing, on a recording medium, and 2) in a case where the second operation member receives the second operation, record a first image on the recording medium, wherein the processor, even in a case where the second operation member has received the second operation, in a case where an image recorded on the recording medium immediately before is the first image, does not record the first image on the recording medium.

One aspect of the present disclosure is a control method of an imaging device including an image sensor, a first operation member capable of receiving a first operation to instruct the image sensor to perform photographing, and a second operation member capable of receiving a second operation, the control method including a first control step of, in a case where the first operation member receives the first operation, controlling the image sensor to perform photographing and recording a photographed image, which has been acquired by the photographing, on a recording medium, and a second control step of, in a case where the second operation member receives the second operation, recording a first image on the recording medium, wherein in the second control step, even in a case where the second operation member has received the second operation, in a case where an image recorded on the recording medium immediately before is the first image, the first image is not recorded on the recording medium.

Features of the present disclosure will become apparent from the following description of embodiments with reference to the attached drawings. The following description of embodiments is described by way of example.

### BRIEF DESCRIPTION OF THE DRAWINGS

FIG. 1 is a configuration diagram of a camera 100 according to Embodiment 1.

FIG. 2 is an external view of the camera 100 according to Embodiment 1.

FIGS. 3A to 3H are diagrams for explaining a separator image according to Embodiment 1.

FIG. 4 is a flowchart of display control processing according to Embodiment 1.

FIG. 5 is a flowchart of processing in response to Fn1 button according to Embodiment 1.

FIG. 6 is a flowchart of processing in response to Fn1 button according to Embodiment 2.

### DESCRIPTION OF THE EMBODIMENTS

Embodiments will now be described with reference to the accompanying drawings.

### Embodiment 1

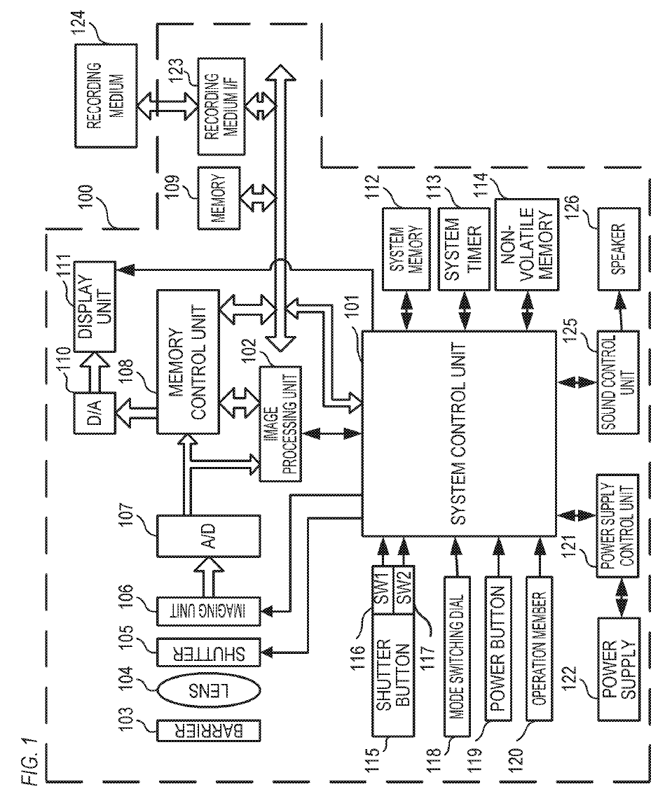

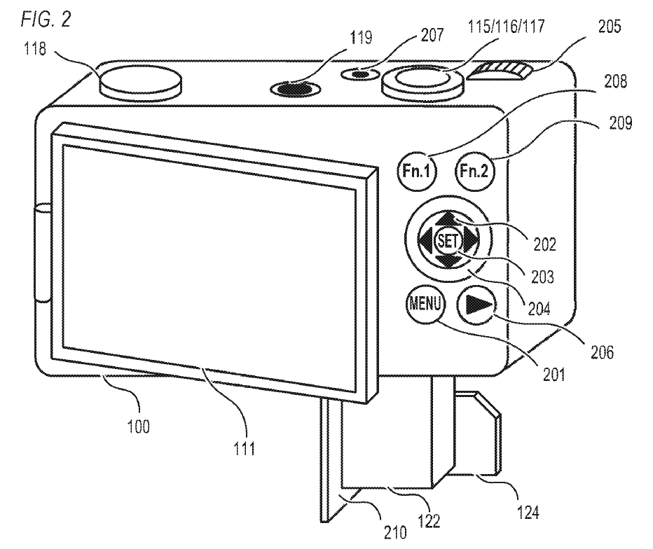

FIG. 1 is a block diagram illustrating a system configuration example of a digital camera 100 (imaging device) according to Embodiment 1. FIG. 2 is an external view of the digital camera 100. Note that Embodiment 1 may be applied to any electronic device (such as a smartphone or a personal computer) including an imaging unit, instead of the digital camera 100.

A photographing lens 104 is a lens group including a zoom lens and a focus lens. A shutter 105 is a shutter with an aperture function. An imaging unit 106 is an imaging element composed of elements (such as CCD or CMOS elements) that convert optical images into electrical signals. The imaging unit 106 acquires a photographed image by capturing an image of real space. An A/D converter 107 converts an analog signal into a digital signal. The A/D converter 107 is used to convert an analog signal output from the imaging unit 106 into a digital signal. A barrier 103 covers an imaging system (including the photographing lens 104) of the digital camera 100. Thus, the barrier 103 prevents the imaging system (including the photographing lens 104, the shutter 105, and the imaging unit 106) from becoming dirty or being damaged.

An image processing unit 102 performs prescribed pixel interpolation, resize processing (such as contraction), or color conversion processing on data from the A/D converter 107 or data from a memory control unit 108. Furthermore, the image processing unit 102 performs prescribed computational processing using captured image data. A system control unit 101 performs exposure control or ranging control on the basis of the obtained computation results. As a result, TTL (through-the-lens) AF (autofocus) processing, AE (automatic exposure) processing, and electronic EF (flash pre-emission) processing are performed. Moreover, the image processing unit 102 performs prescribed computational processing using captured image data and performs TTL AWB (automatic white balance) processing on the basis of the obtained computation results.

The output data from the A/D converter 107 is written directly into the memory 109 via "the image processing unit 102 and the memory control unit 108" or via "the memory control unit 108". The memory 109 stores image data obtained by the imaging unit 106 and converted into digital data by the A/D converter 107. The memory 109 stores image data to be displayed on a display unit 111. The memory 109 has a storage capacity sufficient to store a predetermined number of still images and moving images and audio for a predetermined period of time.

Furthermore, the memory 109 serves as a memory for image display (video memory). A D/A converter 110 converts the data for image display stored in the memory 109 into analog signals and supplies the converted analog signals to the display unit 111. In this way, when the image data for display written in the memory 109 is supplied to the display unit 111 via the D/A converter 110, an image based on the image data is displayed on the display unit 111.

The display unit 111 displays on a display such as an LCD in accordance with the analog signals from the D/A converter 110. The digital signals on which A/D conversion has been performed once by the A/D converter 107 and stored in the memory 109 are then subjected to analog conversion in the D/A converter 110. The display unit 111 functions as an electronic viewfinder by sequentially displaying an image based on the transferred signals, so that it can display a through image (hereinafter referred to as a "live view image").

A non-volatile memory 114 is an electrically erasable and recordable memory. As the non-volatile memory 114, for example, an EEPROM (Electrically Erasable Programmable Read-Only Memory) and the like are used. The non-volatile memory 114 stores constants for operating the system control unit 101, programs, and the like. The programs as used herein refer to programs for executing various flowcharts, which will be described later in the present embodiment.

The system control unit 101 controls the entire digital camera 100. The system control unit 101 executes the programs stored in the non-volatile memory 114 described above to implement types of processing of the present embodiment, which will be described later. A RAM (Random Access Memory) is used as a system memory 112. Constants, variables, programs (programs read from the non-volatile memory 114), and the like used by the system control unit 101 to operate are loaded into the system memory 112. Furthermore, the system control unit 101 also performs display control by controlling the memory 109, the D/A converter 110, the display unit 111, and the like. A system timer 113 is a clocking unit that measures the time used in various types of control and the time of the internal clock.

A shutter button 115, a mode switching dial 118, a power button 119, and an operation unit 120 are each an operation unit for inputting various operation instructions to the system control unit 101.

The mode switching dial 118 switches the operation mode of the system control unit 101 to a detailed mode including "a still image recording mode, a moving image recording mode, and each operation mode".

A first shutter switch 116 turns ON when the shutter button 115 provided on the digital camera 100 is operated halfway, i.e., half-press (photographing preparation instruction), and generates a first shutter switch signal SW1. In response to the first shutter switch signal SW1 generated, an operation is started such as AF (autofocus) processing, AE (automatic exposure) processing, AWB (automatic white balance) processing, or EF (flash pre-emission) processing.

A second shutter switch 117 turns ON when the shutter button 115 is fully operated, i.e., full-press (capture instruction), and generates a second shutter switch signal SW2. In response to the second shutter switch signal SW2 generated, the system control unit 101 starts a series of photographing processing (a series of processing from reading a signal from the imaging unit 106 to writing image data into a recording medium 124).

A power supply control unit 121 includes a battery detection circuit, a DC-DC converter, a switch circuit (a circuit for switching between blocks to be energized), and the like. The power supply control unit 121 detects the state of the power button 119, whether a battery is installed, the type of battery, and the remaining battery power. In addition, the power supply control unit 121 controls the DC-DC converter on the basis of the detection results and an instruction from the control unit 101. As a result, the power supply control unit 121 supplies required voltage to each unit including the recording medium 124 for a required period of time.

A power supply unit 122 includes a primary battery (such as an alkaline battery or a lithium battery), a secondary battery (such as a NiCd battery, a NiMH battery, or a Li battery), an AC adapter, and the like. In the present embodiment, a case where a secondary battery is used as the power supply unit 122 (hereinafter referred to as the "battery 122") will be described.

A recording medium I/F 123 is an interface with the recording medium 124 (such as a memory card or a hard disk). The recording medium 124 is a memory card or the like for recording photographed images. The recording medium 124 includes a semiconductor memory, a magnetic disk, or the like.

The digital camera 100 can give notification such as a warning by sound. Specifically, a speaker 126 can output sound generated by a sound control unit 125.

Operating members of the operation unit 120 operate as a variety of function buttons, respectively. Depending on the selection of various function icons displayed on the display unit 111, functions are assigned to the respective operation members as appropriate. Each operation member is assigned a function button such as an end button, a back button, an image forward button, a jump button, a narrow-down button, or an attribute change button.

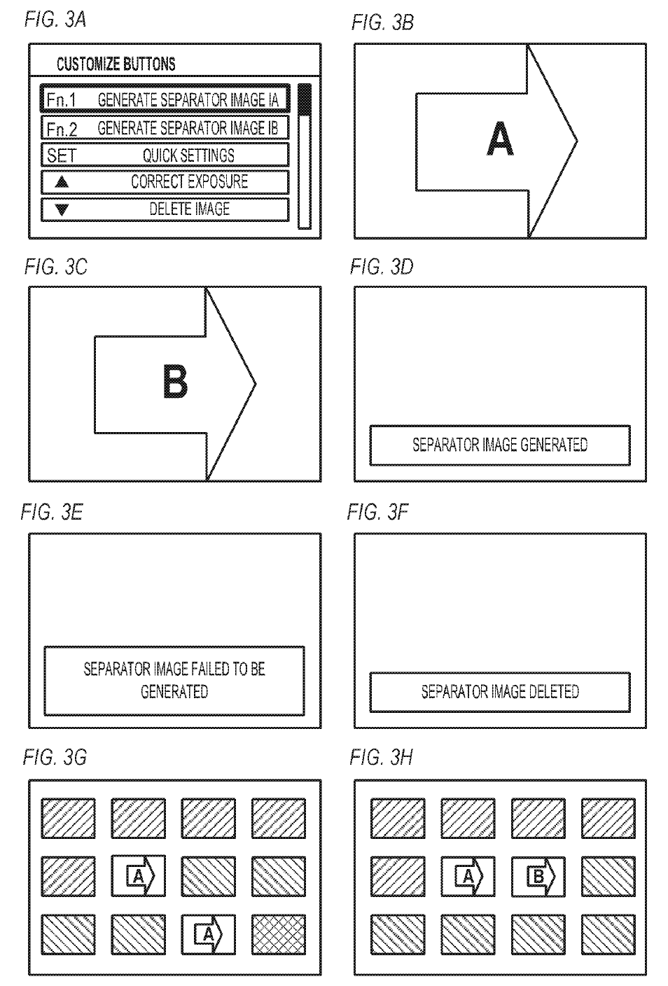

For example, when a menu button 201 illustrated in FIG. 2 is pressed, a menu screen in which various settings can be made is displayed on the display unit 111 (see FIG. 3A). While viewing the menu screen displayed on the display unit 111, the user can intuitively make various settings using a cross button 202 (an operation member having buttons in four directions: up, down, left, and right) and a SET button 203.

A controller wheel 204 and an electronic dial 205 are rotatable operation members included in the operation unit 120. The controller wheel 204 and the electronic dial 205 are used together with the cross button 202 to indicate a selection item. Pressing a playback button 206 makes it possible to switch the digital camera 100 between a photographing mode and a playback mode. Pressing a moving image recording start button 207 makes it possible to start and stop recording of a moving image.

The user can assign any function to each of a function button 208 (hereinafter referred to as the "Fn1 button 208") and a function button 209 (hereinafter referred to as the "Fn2 button 209"). In response to receiving press operation of each function button, the digital camera 100 executes the function assigned to that function button.

The battery 122 and the recording medium 124 can be inserted into the digital camera 100 from the bottom of the digital camera 100. The bottom of the digital camera 100 can be covered with an openable cover 210.

Next, an overview of the generation of a separator image will be described. A function of generating a separator image can be assigned to an operation member on a menu screen such as that illustrated in FIG. 3A. As illustrated in FIGS. 3B and 3C, the separator image is an image that indicates a separation between a plurality of photographed images (images in which a real space is photographed) when a list of the plurality of photographed images is displayed (list playback).

When a button assigned with the function of generating a separator image is pressed in a photographing standby state immediately after continuous shooting has been performed, a separator image is generated as the next image in a series of photographed images. The generated separator image is recorded as a file on the recording medium 124.

With the separator images, even when a plurality of thumbnails with similar designs are displayed side by side in a list display such as that illustrated in FIGS. 3G and 3H, the user can easily visually identify the separations between a plurality of consecutive photographed images. Furthermore, the system control unit 101 may generate a specific separator image at the timing of a predetermined change and record the specific separator image on the recording medium 124. Here, the specific separator image is preferably a separator image different from both separator images IA and IB, which will be described later. This allows the user to easily understand whether or not an image in the list display is a photographed image before the timing of the predetermined change. The timing of the predetermined change is the timing of change in a setting value of the digital camera 100, the timing of lens replacement, the timing of date change, or the like.

In Embodiment 1, two types of separator images are prepared. One of the two types of separator images is called the "separator image IA" (see FIG. 3B), and the other is called the "separator image IB" (see FIG. 3C). As illustrated in FIG. 3A, the separator image IA can be generated by pressing the Fn1 button 208. The separator image IB can be generated by pressing the Fn2 button 209.

The separator images are given file names that comply with a "predetermined naming rule" that is identical to the naming rule for the photographed images, and are recorded on the recording medium 124. The file names may be assigned unique numbers in the order of photographing (order of generation; order of recording). In other words, the predetermined naming rule may be any naming rules that allow files (images) to be rearranged in the order of generation on the basis of the file names. For example, the DCF (Design rule for Camera File system) may be used as the naming rule for still images. Furthermore, the file name may simply be numbers that indicate the date and time of photographing (year + month + day + hour + minute + second). In this case, for example, if the file name of a certain image is "20231117025030", it can be determined that the image was photographed (generated) at 2:50:30 on November 17, 2023. Even when separator images and a plurality of photographed images are transmitted from the digital camera 100 to a PC, the PC can display the separator images at desired positions by arranging the images in order of file number.

Furthermore, in Embodiment 1, the digital camera 100 prevents duplicate separator images from being generated when one function button (the Fn1 button 208 or the Fn2 button 209) is accidentally pressed repeatedly to generate a separator image. Since identical separator images are not generated consecutively, identical separator images are displayed in a list display without being consecutive (without being adjacent to each other horizontally), as illustrated in FIG. 3G. Furthermore, since a plurality of types of separator images each have their own meanings determined by the user, different types of separator images can be generated consecutively, as illustrated in FIG. 3H.

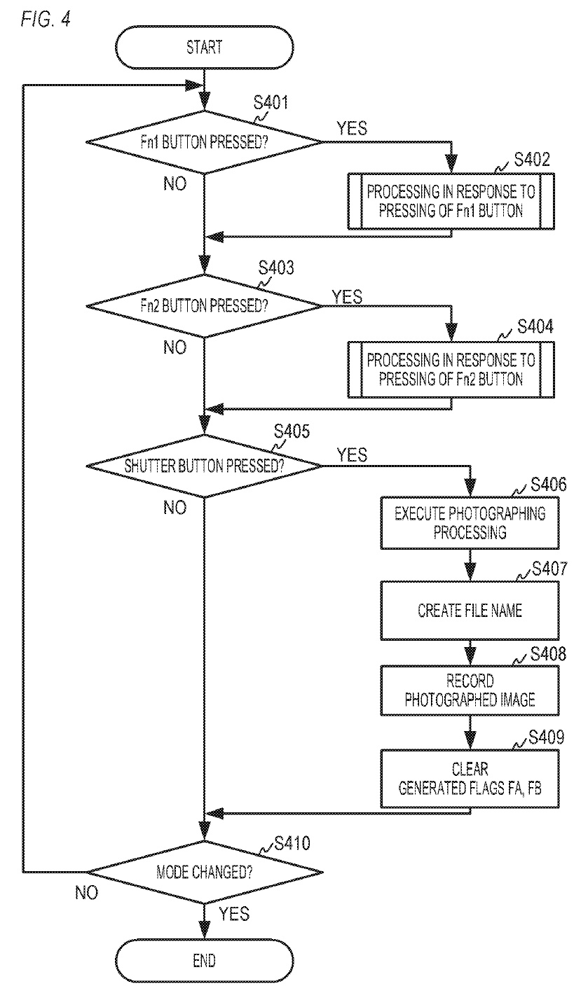

Display control processing of a separator image according to Embodiment 1 will be described with reference to a flowchart of FIG. 4. When the digital camera 100 is set to the photographing mode, the state of the digital camera 100 transitions to the photographing standby state. In the photographing standby state, the processing of the flowchart in FIG. 4 is executed periodically.

In step S401, the system control unit 101 determines whether or not the Fn1 button 208 has been pressed. If it is determined that the Fn1 button 208 has been pressed, the processing proceeds to step S402. If it is determined that the Fn1 button 208 has not been pressed, the processing proceeds to step S403.

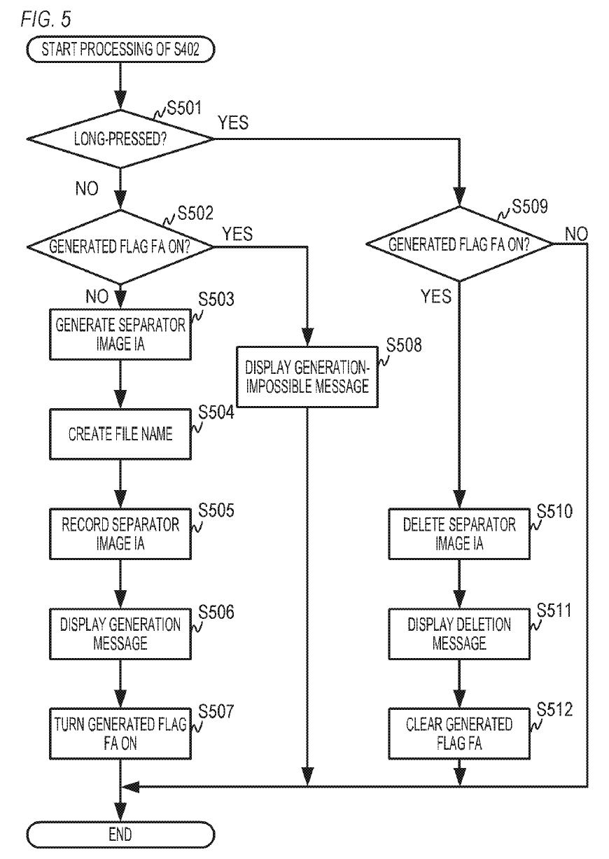

In step S402, the system control unit 101 executes processing in response to the pressing of the Fn1 button 208. Details of the processing of step S402 will be described below with reference to a flowchart of FIG. 5.

In step S403, the system control unit 101 determines whether or not the Fn2 button 209 has been pressed. If it is determined that the Fn2 button 209 has been pressed, the processing proceeds to step S404. If it is determined that the Fn2 button 209 has not been pressed, the processing proceeds to step S405.

In step S404, the system control unit 101 executes processing in response to pressing of the Fn1 button 208. Details of the processing of step S404 are the same as those of the processing of step S402 (processing in the flowchart of FIG. 5). Specifically, in the processing of step S404, the "Fn1 button 208" in the flowchart of FIG. 5 is replaced with the "Fn2 button 209", the "separator image IA" is replaced with the "separator image IB", and a "generated flag FA" is replaced with a "generated flag FB". Therefore, a detailed description of the processing of step S404 will be omitted. Here, when the generated flag FA is ON, it indicates that the separator image IA has already been generated and that no photographed image has been recorded (generated) thereafter. When the generated flag FB is ON, it indicates that the separator image IB has already been generated and that no photographed image has been recorded (generated) thereafter.

In step S405, the system control unit 101 determines whether or not the shutter button 115 has been pressed (whether or not the second shutter switch 117 has been pressed). If it is determined that the shutter button 115 has been pressed, the processing proceeds to step S406. If it is determined that the shutter button 115 has not been pressed, the processing proceeds to step S410.

In step S406, the system control unit 101 controls the imaging unit 22 to perform photographing. Accordingly, the system control unit 101 performs processing to generate a still image (photographed image).

In step S407, the system control unit 101 creates a file name for the generated still image (photographed image) in compliance with a predetermined naming rule.

In step S408, the system control unit 101 records the still image (photographed image) with the created file name on the recording medium 124 as a still image file.

In step S409, the system control unit 101 clears (turns OFF) the generated flag FA for the separator image IA and the generated flag FB for separator image IB. Clearing the generated flag FA and the generated flag FB makes it possible to generate a separator image as the next image. The presence of the generated flags makes it possible to generate (record) only one separator image IA and one separator image IB between photographing. In other words, the presence of the generated flags prevents two or more identical separator images from being generated (recorded) between photographing.

In step S410, the system control unit 101 determines whether or not the operation mode has been changed from the photographing mode. If it is determined that the operation mode has been changed from the photographing mode, the processing of this flowchart ends. If it is determined that the operation mode has not been changed from the photographing mode, the processing proceeds to step S401.

Details of the processing of step S402 will be described with reference to the flowchart in FIG. 5.

In step S501, the system control unit 101 determines whether or not the Fn1 button 208 has been long-pressed. The "long-press" as used herein refers to an operation to hold pressing for a period of time longer than a predetermined period of time (e.g., one or two seconds). If it is determined that the Fn1 button 208 has been long-pressed, the processing proceeds to step S509. If it is determined that the Fn1 button 208 has not been long-pressed (has been pressed and held for a period of time shorter than the predetermined period of time), the processing proceeds to step S502.

In step S502, the system control unit 101 determines whether or not the generated flag FA is ON. If it is determined that the generated flag FA is ON, the processing proceeds to step S508. If it is determined that the generated flag FA is not ON, the processing proceeds to step S503.

In step S503, the system control unit 101 generates a separator image IA.

In step S504, the system control unit 101 creates a file name for the separator image IA in compliance with a predetermined naming rule. Here, the predetermined naming rule is identical to the naming rule for a file name for the still image described in step S407.

In step S505, the system control unit 101 records the separator image IA on the recording medium 124 using the created file name.

In step S506, the system control unit 101 displays a message on the display unit 111 indicating that the separator image IA has been generated (recorded), as illustrated in FIG. 3D.

In step S507, the system control unit 101 sets the generated flag FA to ON.

In step S508, the system control unit 101 does not perform the processing to generate the separator image IA because generation of identical separator images is prohibited. Therefore, the system control unit 101 displays a message on the display unit 111 indicating that generation (recording) of the separator image IA is impossible, as illustrated in FIG. 3E.

In step S509, the system control unit 101 determines whether or not the generated flag FA is ON. If it is determined that the generated flag FA is ON, the processing proceeds to step S510. If it is determined that the generated flag FA is not ON, the processing of this flowchart ends, and then the processing proceeds to the next step (step S403) in the flowchart of FIG. 4. Note that if it is determined that the generated flag FA is not ON, no separator image IA has been recorded after the recording of a photographed image immediately before (the photographing immediately before), and therefore processing to delete the separator image IA in step S510 is not performed.

In step S510, the system control unit 101 deletes from the recording medium 124 the file of the separator image IA recorded immediately before.

In step S511, the system control unit 101 displays a message on the display unit 111 indicating that the separator image IA has been deleted, as illustrated in FIG. 3F.

In step S512, the system control unit 101 clears the generated flag FA.

According to Embodiment 1, when the user presses a specific button between photographing, a separator image is recorded at the timing intended by the user. Furthermore, since the continuous generation of identical separator images is prohibited, it is possible to prevent the unintended recording of a separator image due to an erroneous operation by the user. Therefore, when a list of a plurality of photographed images is displayed, a separator image is displayed in the location intended by the user, and as a result, the user and other viewers of the list display can intuitively understand the separation (group) intended by the user among the plurality of photographed images.

Note that, in Embodiment 1, a method for generating two types of separator images has been described, but the number of types of separator images may be one, or three or more, and may be equal to the number of operation members to which functions can be assigned. Furthermore, a method for generating (recording) and deleting a separator image by operating an operation member has been described, but in Embodiment 1, a separator image may be generated or deleted by an operation such as pressing the operation member twice in a short period of time, in addition to the long-press of the operation member described above. Moreover, by assigning a function for deleting a separator image to an operation member to which a function can be assigned, when the operation member is operated, the separator image immediately before may be deleted.

In Embodiment 1, a generated flag is used to determine whether or not a specific separator image has been recorded after the recording of a photographed image immediately before. The digital camera 100 may check the additional information of an image file recorded on the recording medium 124 and determine, based on whether the attribute of the file indicates a specific separator image, whether or not a specific separator image has been recorded after the recording of a photographed image immediately before.

Note that, in step S507, the system control unit 101 may execute processing to turn on the generated flag FA and clear the generated flag FB. According to this processing, even if a separator image IB has been generated (recorded) after the acquisition of a photographed image immediately before (after the photographing immediately before), it is possible to generate (record) a subsequent separator image IB. In this case, generation of a separator image IB is prohibited only when the image recorded on the recording medium 124 immediately before is a separator image IB. On the other hand, generation of a separator image IB is not prohibited when the image recorded on the recording medium 124 immediately before is a photographed image or a separator image IA. This enables generation (recording) of a separator image IB, followed by a separator image IA, followed by a separator image IB in this order.

### Embodiment 2

In Embodiment 2, the digital camera 100 generates (records) a separator image when a specific button is operated, and deletes the separator image immediately before when the specific button is operated again.

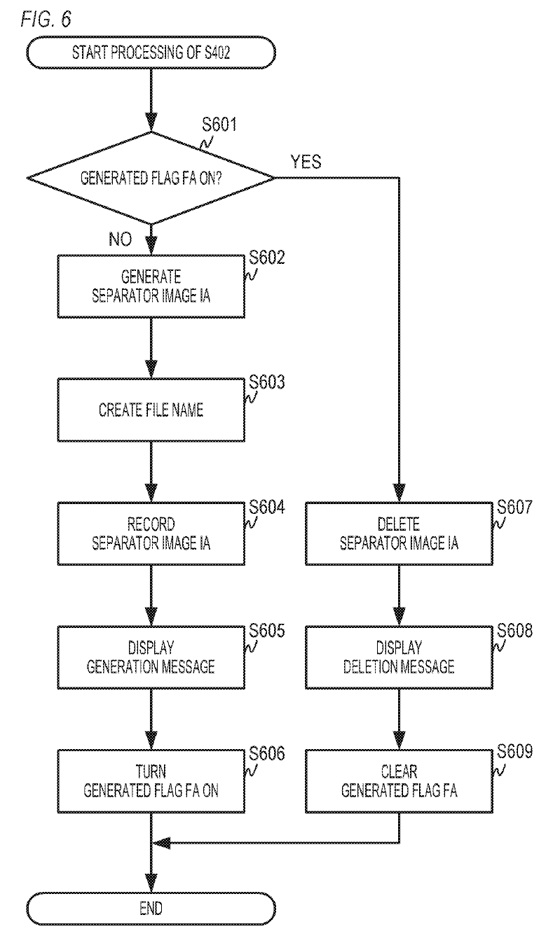

The processing of the flowchart of FIG. 4 is executed also in Embodiment 2, but only the processing of steps S402 and S404 differs from that in Embodiment 1. Therefore, details of the processing of step S402 (processing in response to pressing of the Fn1 button 208) will be described below with reference to a flowchart in FIG. 6.

Note that the processing of step S404 is the same as the processing of step S402 (the processing of the flowchart in FIG. 6). Specifically, the processing of step S404 differs from the flowchart in FIG. 6 only in that the "separator image IA" is replaced with the "separator image IB" and the "generated flag FA" is replaced with the "generated flag FB". Therefore, a detailed description of the processing of step S404 will be omitted.

In step S601, the system control unit 101 determines whether or not the generated flag FA is ON. If it is determined that the generated flag FA is ON, the processing proceeds to step S607. If it is determined that the generated flag FA is not ON, the processing proceeds to step S602.

In step S602, no separator image IA has been recorded on the recording medium 124 after the recording of a photographed image immediately before (after the photographing immediately before), and therefore the system control unit 101 generates a separator image IA.

In step S603, the system control unit 101 creates a file name for the separator image IA in compliance with a predetermined naming rule, as in step S504.

In step S604, the system control unit 101 records the separator image IA on the recording medium 124 using the created file name.

In step S605, the system control unit 101 displays a message on the display unit 111 indicating that a separator image IA has been generated, as illustrated in FIG. 3D.

In step S606, the system control unit 101 sets the generated flag FA to ON.

In step S607, the system control unit 101 deletes from the recording medium 124 the file of the separator image IA immediately before.

In step S608, the system control unit 101 displays a message on the display unit 111 indicating that the separator image IA has been deleted, as illustrated in FIG. 3F.

In step S609, the system control unit 101 clears the generated flag FA.

In Embodiment 2, when a specific button is operated, the digital camera 100 determines whether or not a specific separator image has been recorded (generated) after the recording of a photographed image immediately before. Then, the digital camera 100 switches between generating and deleting a separator image depending on the determination result, thereby making it possible to prevent identical separator images from being generated continuously.

While the present disclosure has been described in detail based on preferred embodiments thereof, the present disclosure is not limited to the specific embodiments and various modes without departing from the scope and spirit of the disclosure are also included in the present disclosure. Parts of the embodiments described above may be appropriately combined with each other.

Furthermore, in the above description, "processing proceeds to step S1 when A is at least B, and proceeds to step S2 when A is smaller (lower) than B" may be read as "processing proceeds to step S1 when A is larger (higher) than B, and proceeds to step S2 when A is not more than B". Conversely, "processing proceeds to step S1 when A is larger (higher) than B, and proceeds to step S2 when A is not more than B" may be read as "processing proceeds to step S1 when A is at least B, and proceeds to S2 when A is smaller (lower) than B". Therefore, unless contradiction arises, "at least A" may be read as "larger (higher, longer, or greater) than A", and "not more than A" may be read as "smaller (lower, shorter, or less) than A". Furthermore, "larger (higher, longer, greater) than A" may be read as "at least A", and "smaller (lower, shorter, or less) than A" may be read as "not more than A".

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

The embodiment described above (including variation examples) is merely an example. Any configurations obtained by suitably modifying or changing some configurations of the embodiment within the scope of the subject matter of the present disclosure are also included in the present disclosure. The present disclosure also includes other configurations obtained by suitably combining various features of the embodiment.

According to the present disclosure, when recording a plurality of photographed images on a medium, the imaging device can record a separator image on the medium at a timing intended by the user.

### Other embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. An imaging device comprising:
an image sensor;
a first operation member capable of receiving a first operation to instruct the image sensor to perform photographing;
a second operation member capable of receiving a second operation; and
a processor configured to, 1) in a case where the first operation member receives the first operation, control the image sensor to perform photographing and record a photographed image, which has been acquired by the photographing, on a recording medium, and 2) in a case where the second operation member receives the second operation, record a first image on the recording medium, wherein
the processor, even in a case where the second operation member has received the second operation, in a case where an image recorded on the recording medium immediately before is the first image, does not record the first image on the recording medium.

2. The imaging device according to claim 1, wherein the processor,
in a case where the first operation member receives the first operation, records on the recording medium the photographed image having a file name in compliance with a predetermined naming rule, and
in a case where the second operation member receives the second operation, records the first image with a file name in compliance with the predetermined naming rule on the recording medium.

3. The imaging device according to claim 1, wherein the processor, even in a case where the second operation member has received the second operation, in a case where the first image has been recorded on the recording medium after recording of the photographed image immediately before, does not record the first image on the recording medium.

4. The imaging device according to claim 1, further comprising a third operation member capable of receiving a third operation, wherein
the processor, 1) in a case where the third operation member receives the third operation, if an image recorded on the recording medium immediately before is the second image, does not record the second image on the recording medium, and 2) in a case where the third operation member receives the third operation, if the image recorded on the recording medium immediately before is not the second image, records the second image on the recording medium.

5. The imaging device according to claim 1, wherein
the second operation member is capable of receiving the second operation and a fourth operation, and
the processor, in a case where the second operation member receives the fourth operation, deletes from the recording medium the first image recorded on the recording medium immediately before.

6. The imaging device according to claim 5, wherein
the second operation is a press operation for a period of time shorter than a predetermined period of time, and
the fourth operation is a press operation for a period of time longer than the predetermined period of time.

7. The imaging device according to claim 1, wherein the processor,
in a case where the second operation member receives the second operation, if an image recorded on the recording medium immediately before is not the first image, records the first image on the recording medium, and
in a case where the second operation member receives the second operation, if an image recorded on the recording medium immediately before is the first image, deletes from the recording medium the first image recorded on the recording medium immediately before.

8. The imaging device according to claim 1, wherein the processor records a third image on the recording medium at timing of change in a setting value of the imaging device, timing of lens replacement of the imaging device, or timing of date change.

9. A method for controlling an imaging device including an image sensor, a first operation member capable of receiving a first operation to instruct the image sensor to perform photographing, and a second operation member capable of receiving a second operation, the method comprising:
a first control step of, in a case where the first operation member receives the first operation, controlling the image sensor to perform photographing and recording a photographed image, which has been acquired by the photographing, on a recording medium; and
a second control step of, in a case where the second operation member receives the second operation, recording a first image on the recording medium, wherein
in the second control step, even in a case where the second operation member has received the second operation, in a case where an image recorded on the recording medium immediately before is the first image, the first image is not recorded on the recording medium.

10. A non-transitory computer readable medium that stores a program, wherein the program causes a computer to execute a method for controlling an imaging device including an image sensor, a first operation member capable of receiving a first operation to instruct the image sensor to perform photographing, and a second operation member capable of receiving a second operation, the method comprising:
a first control step of, in a case where the first operation member receives the first operation, controlling the image sensor to perform photographing and recording a photographed image, which has been acquired by the photographing, on a recording medium; and
a second control step of, in a case where the second operation member receives the second operation, recording a first image on the recording medium, wherein
in the second control step, even in a case where the second operation member has received the second operation, in a case where an image recorded on the recording medium immediately before is the first image, the first image is not recorded on the recording medium.
